(19) United States
(12) Patent Application Publication
(10) Pub. No.: US 2004/0196402 A1
(43) Pub. Date: Oct. 7, 2004

(54) Image pickup device and electronic camera

(76) Inventors: Chisato Yoshida, Saitama (JP); Naoki Kamaya, Tokyo (JP)

Correspondence Address: William S Frommer, Frommer Lawrence & Haug, 745 Fifth Avenue, New York, NY, 10151, US

(21) Appl. No.: 10/488,113

(22) PCT Filed: Jun. 24, 2003
(86) PCT No.: PCT/JP03/07997

(30) Foreign Application Priority Data
Jun. 28, 2002 (JP) 2002-191150

(51) Int. Cl. H04N 5/222

(52) U.S. Cl. 348/371

(57) ABSTRACT

In order to inform the user and others properly of an end of photographing after a shutter has been released or of taking an object image has been completed, in an image pick-up apparatus having a flash 16, when lighting of the flash 16 is not necessary at a time of photographing, the flash 16 is made to turn on at a timing other than the time of photographing in relation to the time of photographing.

### TECHNICAL FIELD

The present invention relates to an image pick-up apparatus such as a camera, a digital still camera and an electronic camera such as a digital still camera.

### BACKGROUND ART

Conventionally, a flash (strobe light) is provided in an image pick-up apparatus such as a camera or a digital still camera, and the flash (strobe light) is turned on at a time of picking up images when brightness is insufficient in a dimly illuminated place or when performed against the light even in a bright place, so that an amount of light is compensated.

Hitherto, there has been proposed an image pick-up apparatus provided, in order to turn on the flash, with a flashlight-necessity judging means for judging whether or not lighting of the flush lamp is necessary and in the apparatus the flash is automatically turned on, when the flashlight-necessity judging means judges that lighting of the flush lamp is necessary.

Also, there has been proposed a conventional digital still camera, in which in order to enable the user to confirm that image pick-up has been performed, a speaker is provided to generate a shutter sound of the digital still camera, or a tally lamp formed of a red LED or the like is provided such that the tally lamp is turned on immediately after the pick-up when picking up an image.

However, when taking an image of a plurality of people without using a flash, for example, at an indoor party or at an outdoor event or the like, there was an inconvenience that even if a shutter sound was produced from an image pick-up apparatus or a tally lamp was turned on, it was difficult to notice the sound or lamp in noisy circumstances and the people hardly knew when image pick-up was finished and kept posing themselves even after image pick-up was finished.

Particularly, when the picture is taken by having an owner of the image pick-up apparatus separated from the image pick-up apparatus in such cases as asking a person who is unfamiliar with the apparatus to take a picture or performing that by a timer using a tripod, there was an inconvenience that it was hard to notice when the shutter was released.

On the other hand, in the case where the image pick-up apparatus is an electronic camera such as a digital still camera, in comparison to a photographic apparatus which uses a silver halide film (camera), the electronic camera is capable of taking a picture at a darker place than the photographic apparatus. In other words, it is possible in case of an electronic camera to take a picture in an illuminated room without using a flash.

On the contrary, in the case where a flash was used in an illuminated room when taking a picture by an electronic camera, there was an inconvenience that a photographed picture became yellowish if a signal processing portion of the electronic camera adjusted a white balance based on brightness lit up with a flash, when the room was illuminated with, for example, incandescent lamps. Moreover, when the picture is taken by having a flash turned on, there was such a case that the light was projected to a whole face and the photographed face became flat.

### DISCLOSURE OF THE INVENTION

In view of the above, the present invention aims at properly informing of completion of photographing after a shutter has been released or image pick-up has been completed.

An image pick-up apparatus according to the present invention is the image pick-up apparatus having a flash, wherein when lighting of the flash is not necessary at a time of photographing, the flash is made to turn on in relation to the photographing at a timing other than the photographing.

According to the present invention, when photographing is performed in which lighting of the flash is not necessary at the time of photographing, since the flash is made to turn on at the timing other than the time of photographing in relation to the time of photographing, a flash is turned on at a time of photographing or at a timing other than the time of photographing, and an end of photographing can be properly noticed by the lighting of the flash.

An image pick-up apparatus according to the present invention is the image pick-up apparatus having a flash, which is provided with a flashlight-necessity judging means for judging whether or not lighting of the flash is necessary at a time of photographing; when the flashlight-necessity judging means judges that lighting of the flash is necessary, the flash is made to turn on at the time of photographing; and when the flashlight-necessity judging means judges that lighting of the flash is not necessary, the flash is made to turn on at a timing other than the time of photographing in relation to the time of photographing.

Therefore, according to the present invention, since a flash is turned on at a time of photographing or at a timing other than the time of photographing in relation to the photographing, an end of photographing can be properly noticed by the lighting of the flash.

### BRIEF DESCRIPTION OF DRAWINGS

FIG. 1 is a block diagram showing an embodiment of a image pick-up apparatus according to the present invention;

FIG. 2 is a front perspective view showing an external appearance of an example of a digital still camera according to the present invention;

FIG. 3 is a rear perspective view showing an external appearance of an example of a digital still camera according to the present invention;

FIG. 4 is a flow chart for explaining the present invention;

FIG. 5 is a diagram for explaining the present invention; and

FIG. 6 is a flow chart for explaining the present invention.

### BEST MODE FOR CARRYING OUT THE INVENTION

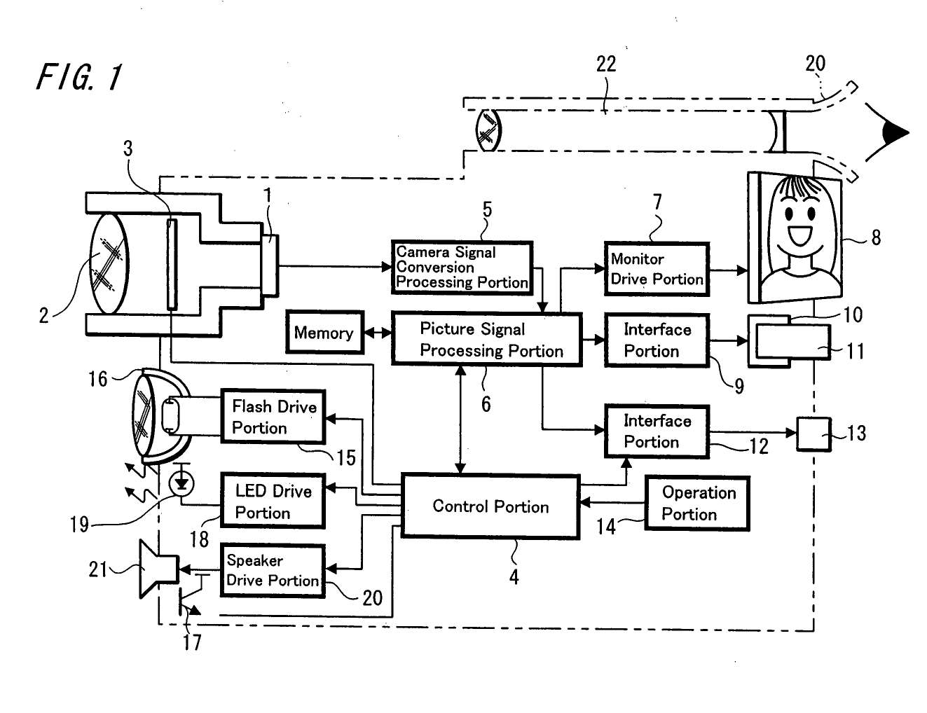

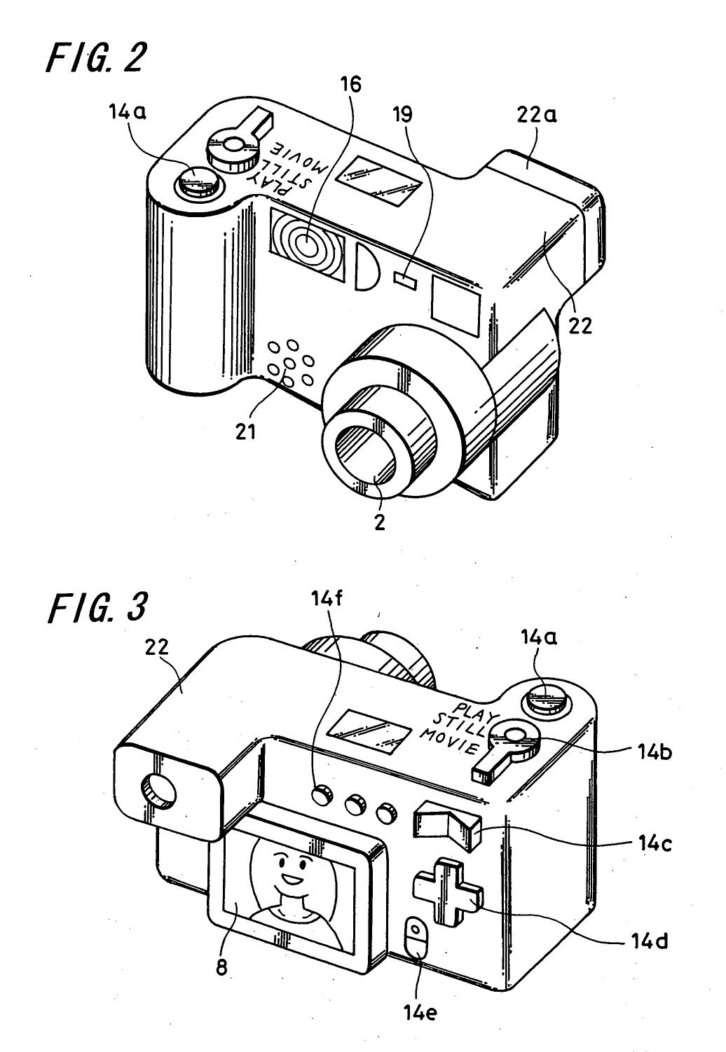

Hereinafter, embodiments of an image pick-up apparatus and an electronic camera according to the present invention will be explained referring to the drawings. FIG. 1 shows a configuration of an example of a digital still camera according to the embodiment, FIG. 2 is a front view showing an external appearance of the digital still camera, and FIG. 3 is a rear view showing an external appearance of the digital still camera.

In FIG. 1, a reference numeral 1 denotes an image pickup device such as a charge coupled device (CCD) and an object image is taken into the image pickup device 1 through an objective lens 2. Taking the object image into the image pickup device 1 is performed by a combination of a mechanical shutter 3 and an electronic shutter controlled by a control portion 4 composed of a microcomputer, explained later on.

In the image pickup device 1, the object image obtained is converted into electrical signals and then the electrical signals are supplied to a camera signal conversion processing portion 5. The camera signal conversion processing portion 5 converts the electrical signals supplied from the image pickup device 1 into picture signals. The picture signals obtained at an output side of the camera signal conversion processing portion 5 are supplied to a picture signal processing portion 6.

The picture signal processing portion 6 performs predetermined picture signal processing such as a white balance adjustment of the picture signals supplied from the camera signal conversion processing portion 5, and the processed picture signals are supplied through a monitor drive portion 7 to a monitor portion 8 composed of, for example, a liquid crystal display monitor.

Further, the picture signals obtained in the picture signal processing portion 6 are supplied to a memory device connector 10 through an interface portion 9, and the picture signals are recorded on a memory device. 11 such as a memory stick (brand name) which is connected to the memory device connector 10. In this case, in the picture signal processing portion 6 signal compression processing such as JPEG compression is performed on the picture signals. Also, the picture signals obtained in the picture signal processing portion 6 are supplied to an outside connector 13 which supplies the picture signals to the outside, through an interface portion 12 controlled by the control portion 4.

Further, in FIG. 1, a reference numeral 14 denotes an operation portion such as a release button 14a, a mode selection button 14b, a zoom button 14c, a program selection button 14d, a power button 14e, a flash selection button 14f, and similar.

In this embodiment, flash control signals from the control portion 4 are supplied to a flash 16 through a flash drive portion 15 so as to turn on the flash 16. The flash 16 is made to turn on at the time of photographing, when a sensor 17 detecting brightness around the digital still camera detects that lighting of the flash 16 is necessary, and also when the flash selection button 14f is operated.

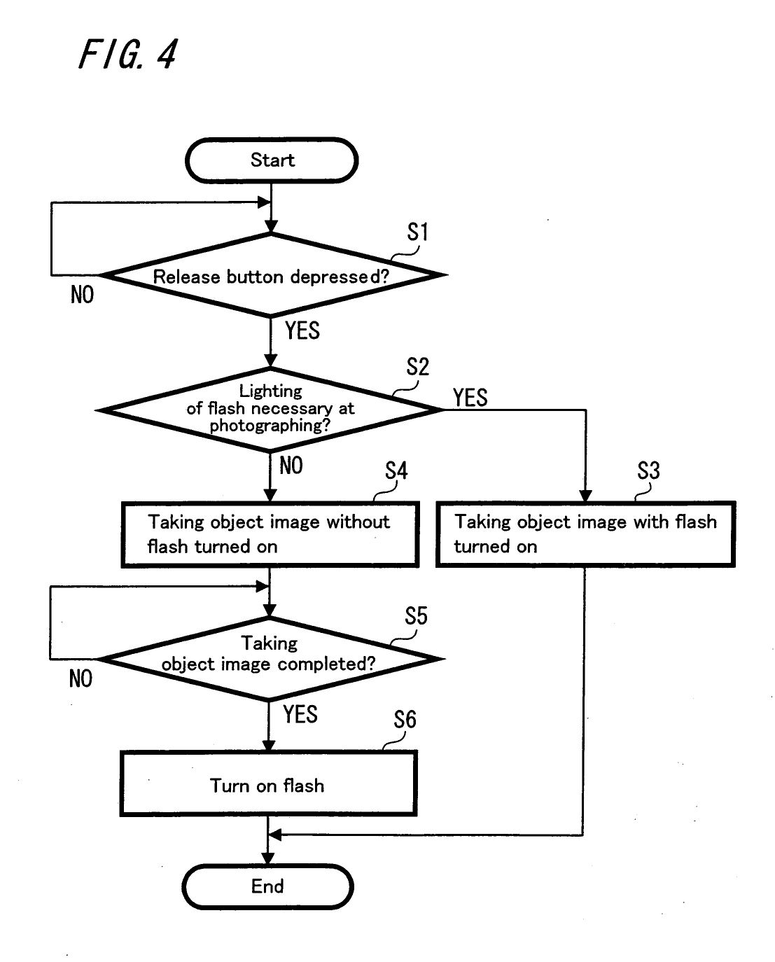

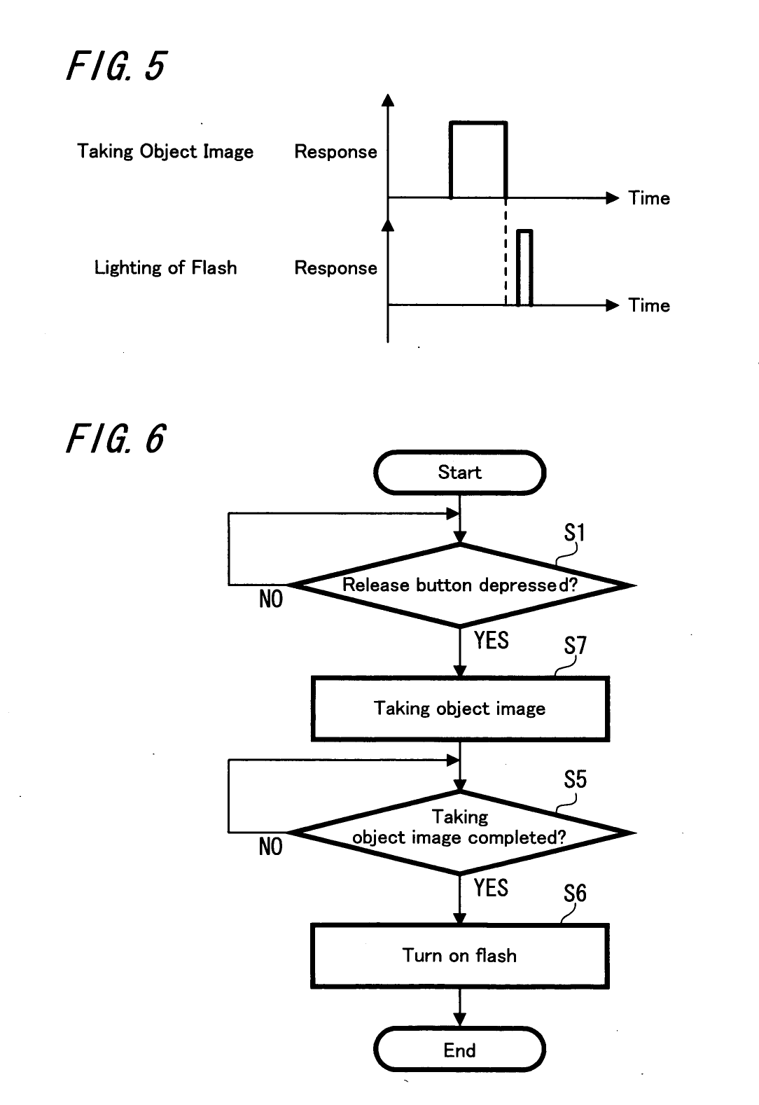

Further, in this embodiment, when lighting of the flash 16 is not necessary at a time of photographing, the flash 16 is made to turn on immediately after the time of photographing as shown in FIGS. 4 and 5.

Hereupon, a control operation on the flash 16 by the control portion 4 according to this embodiment is shown in FIG. 4. As explained in FIG. 4, first, a judgment is made whether the release button 14a has been depressed (step S1) so as to judge whether photographing is performed. When the release button 14a has been depressed, a judgment is made by the flashlight-necessity judging means (control portion 4) whether lighting of the flash 16 is necessary at the time of photographing (step S2). The time at which lighting of the flash 16 is necessary is when the flash 16 is compulsorily turned on by the flash selection button 14f at photographing against the light or the like, and also when lighting of the flash 16 is necessitated by an output of the sensor 17.

When it is judged at the step 2 that lighting of the flash 16 is necessary, an object image is taken into the image pickup device 1 with having the flash 16 turned on (step S3) and then, the photographing is finished.

Also, when it is judged at the step S2 that lighting of the flash 16 is not necessary, an object image is taken into the image pickup device 1 without having the flash 16 turned on (step S4), and thereafter a judgment is made whether taking of the object image into the image pickup device 1 has been completed (step S5); when taking the object image into the image pickup device 1 has been completed, the flash 16 is turned on (step S6) so as to give a sign for an end of photographing; and then the photographing is finished.

In this case, since lighting of the flash 16 at a time other than the photographing is performed only for the purpose of giving a sign, electrical power shall be made less than lighting of the flash 16 at a time of photographing, so that electrical power consumption can be reduced. Consequently, a load on a as a power source can be lessened.

Also, a tally lamp control signal from the control portion 4, which is generated immediately after photographing, is supplied to a tally lamp 19 formed of a red LED through a LED drive portion 18, so that the tally lamp 19 formed of the red LED can emit light immediately after the time of photographing.

A shutter sound caused by depressing the release button 14a is supplied from the control portion 4 to a speaker 21 through a speaker drive portion 20, so that the shutter sound can be generated from the speaker 21.when the release button 14a is depressed. Further, in FIG. 1, a reference numeral 22 denotes a view finder and a reference numeral 22a denotes an eye cup.

According to the above embodiment, since the flash 16 is turned on at a time of photographing or immediately after photographing in relation to the photographing, an end of photographing can be noticed appropriately by using the lighting of the flash 16 as a sign. Therefore, according to the embodiment, not only a person performing photographing but also people being photographed can confirm without fail that the photographing has been completed.

Particularly, in case of an electronic camera such as a digital still camera, there exists a camera which does not start photographing immediately after the release button 14a is depressed and needs to keep depressing the button in order to start photographing, and regarding such electronic still camera, it is difficult to explain how to take a photograph when asking another person; however, according to an electronic camera of this embodiment, it is possible to ask simply and unmistakably by explaining “a release button shall be depressed until a flash is turned on”.

Further, in the above embodiment it is explained that when lighting of the flash 16 is not necessary at a time of photographing, the flash 16 is turned on immediately after the photographing in relation to the time of photographing so as to give a sign for an end of the photographing; however, the flash 16 may be turned on just before the photographing, because the lighting of the flash 16 is used as a sign of photographing according to this embodiment and the time of photographing is very short.

Furthermore, although a flashlight-necessity judging means is provided, as shown in FIG. 4, in the above embodiment so as to judge whether or not lighting of the flash 16 is necessary at a time of photographing, the flash 16 may be made to turn on after an object image is taken in, as shown in FIG. 6, without judging whether or not lighting of the flash 16 is necessary at the time of photographing.

In FIG. 6, parts corresponding to those in FIG. 4 shall be explained by giving the same reference numerals. First, a judgment is made whether the release button 14a has been depressed (step S1) so as to judge whether it is a time of photographing. When the release button 14a has been depressed, an object image is taken into the image pickup device 1 (step S7).

Thereafter, a judgment is made whether the taking of the object image into the image pickup device 1 has been completed (step S5); when the taking of the object image into the image pickup device 1 has been completed, the flash 16 is turned on (step S6) so as to give a sign for an end of photography; and then, the photographing is finished When photographing is performed by using a timer, the lighting of the flash 16 shall be performed in conjunction with a shutter operation by the timer. Generally, people being photographed are separated from a camera when photographing using a timer; however, if the lighting of the flash 16 is performed in conjunction with the shutter operation by the timer, it can be noticed without fail that the photographing has been completed.

Also in this embodiment, when “a movie mode” is selected by the mode selection button 14b to employ a moving picture photographing mode, photographing of a moving picture is, for example, performed for 15 seconds by operating the release button 14a. In this case, the flash 16 in this embodiment is made to turn on after photographing a moving picture, for example, for 15 seconds.

According to this embodiment, it is convenient that completion of photographing a moving picture can be noticed.

As heretofore described, according to the present invention since a flash is turned on at a time of photographing or at a timing other than the time of photographing in relation to photographing, an end of photographing can be noticed properly by using the lighting of the flash as a sign.

Therefore, according to the present invention, not only a person photographing but also people being photographed can confirm without fail that the photographing has been completed.

Further, particularly in case of an electronic camera such as a digital still camera, there is one which does not start photographing immediately after a release button is depressed and needs to keep depressing the button in order to start photographing, and with respect to such an electronic still camera it is difficult to explain how to photograph when asking another person to take a picture; however according to the electronic camera of the embodiment, it is possible to ask simply and unmistakably by explaining “a release button shall be depressed until a flash is turned on”.

Further, in the above embodiment although an explanation is made to an example in which the present invention is applied to a digital still camera, the present invention can undoubtedly be applied to a image pick-up apparatus such as a camera, an analogue type electronic camera, a digital or analogue video camera, and a portable phone having a built-in camera.

Furthermore, the present invention is not limited to the above-stated embodiments and various modified configurations can be adopted within the purport of the present invention.

### Description of Reference Numerals

1 IMAGE PICKUP DEVICE

4 CONTROL PORTION

5 CAMERA SIGNAL CONVERSION PROCESSING PORTION

6 PICTURE SIGNAL PROCESSING PORTION

8 MONITOR

11 MEMORY DEVICE

14 OPERATION PORTION

14a RELEASE BUTTON

14b MODE SELECTION BUTTON

15 FLASH DRIVE PORTION

16 FLASH

1. An image pick-up apparatus having a flash, wherein
when lighting of said flash is not necessary at a time of photographing, said flash is made to turn on in relation to said time of photographing at a timing other than said time of photographing.

2. The image pick-up apparatus according to claim 1, wherein
said flash is made to turn on after the time of photographing.

3. An electronic camera having a flash, wherein
when lighting of said flash is not necessary at a time of photographing, said flash is made to-turn on in relation to said time of photographing at a timing other than said time of photographing.

4. The image pick-up apparatus according to claim 1, wherein
a timer mode is provided and photographing is performed by said timer mode.

5. The image pick-up apparatus according to claim 1, wherein
lighting of the flash at the timing other than said time of photographing is performed by lower electrical power than lighting of the flash at said time of photographing.

6. An image pick-up apparatus having a flash, wherein
a flashlight-necessity judging means is provided to judge whether or not lighting of the flash is necessary at a time of photographing;
when said flashlight-necessity judging means judges that lighting of the flash is necessary, said flash is made to turn on at said time of photographing, and when said flashlight-necessity judging means judges that lighting of the flash is not necessary at the time of photographing, said flash is made to turn on at a timing other than said time of photographing in relation to said time of photographing.

7. The electronic camera according to claim 3, wherein
a moving picture photographing mode is provided, and in said moving picture photographing mode, said flash is made to turn on immediately after having completed photographing a moving picture.
